(19) United States
(12) Patent Application Publication
(10) Pub. No.: US 2009/0242043 A1
(43) Pub. Date: Oct. 1, 2009

(54) HYDROGEN SUPPLY PRESSURE REGULATOR

(75) Inventors: Leonid C. Lev, West Bloomfield, MI (US); Dimitri A. Podorashi, Weiterstadt (DE); Michael J. Lukitsch, Marysville, MI (US); Rainer Pechtold, Hunstetten (DE); Hans Weidner, Darmstadt (DE)

Correspondence Address: General Motors Corporation;c/o REISING, ETHINGTON, BARNES, KISSELLE, P.C., P.O. BOX 4390, TROY, MI, 48099-4390, US

(73) Assignee: GM GLOBAL TECHNOLOGY OPERATIONS, INC., Detroit, MI (US)

(21) Appl. No.: 12/361,818

(22) Filed: Jan. 29, 2009

Related U.S. Application Data
(60) Provisional application No. 61/040,804, filed on Mar. 31, 2008.

(51) Int. Cl. G05D 16/06

(52) U.S. Cl. 137/505.25; 137/505; 137/509; 137/510

(57) ABSTRACT

Hydrogen gas flow from high pressure storage to a lower pressure hydrogen-using device is managed using one or more axial flow pressure regulators comprising a cup-shaped housing with an inlet for high pressure hydrogen gas at one end of the flow axis and a closure with a low pressure hydrogen outlet at the other end of the flow axis. A piston head with a piston stem are aligned on the flow axis and a hydrogen flow passage is formed up the stem and through the piston head to the hydrogen flow outlet. One or more combinations of a corrugated tubular bellows (or like expansive sealing vessel) with static seals attaching one bellows end to the piston stem or head and the other bellows end to the housing or closure are used to accommodate axial movement of the piston while isolating and containing hydrogen gas flow from a high pressure chamber at a flow entrance to the piston stem to a low hydrogen pressure chamber at the piston head and closure outlet.

This application claims the benefit of U.S. Provisional Application No. 61/040,804, filed on Mar. 31, 2008. The disclosure of that application is incorporated herein by reference in its entirety.

### TECHNICAL FIELD

This invention pertains to the delivery of hydrogen gas from a high pressure storage container to a hydrogen-consuming fuel cell, or other hydrogen-consuming or using device, at a lower pressure. More specifically, this invention pertains to a pressure regulator with a body and a piston defining a high pressure hydrogen chamber and a reduced pressure chamber and using a combination of bellows and seals to deliver hydrogen without leaks and with minimal friction.

### BACKGROUND OF THE INVENTION

Hydrogen is a clean fuel that may be used to produce electricity in a fuel cell. The automotive vehicle industry and others are interested in adapting hydrogen fuel cells for power generation.

A hydrogen fuel cell is an electrochemical device that comprises an anode and cathode separated by and connected to a proton-conducting electrolyte. The anode receives a flow of hydrogen gas and the cathode receives a flow of oxygen or air. Many individual cells may be stacked in series flow arrangement to deliver an electrical current at a specified power level. The fuel cell may be operated to generate an electrical current to drive an electric motor or other power-consuming device.

A fuel cell stack is operated by drawing hydrogen gas from a nearby storage vessel in which hydrogen is typically stored under relatively high pressure. One or more flow control pressure regulators may be employed to provide a pressure reduction of a hydrogen stream flowing from its high pressure storage to anode chambers of the fuel cell stack. The flow control pressure regulator(s) may be required to reduce hydrogen pressure from 30-700 bar tank pressure to 4-9 bar line pressure. Then, at an input manifold to the anode side of the fuel cell stack, the pressure may be further reduced from 4-9 bar line pressure to 1-2 bar anode chamber pressure. In each of these flow regulators the hydrogen flow rate may vary widely, e.g., between 0.02 and 2.0 g/s.

The operating temperatures of the pressure regulators are subject to conflicting influences. The temperature in on-board hydrogen storage vessels may vary in a range from about −80° C. to 85° C., depending on driving cycle and filling status. After refueling, hydrogen temperature may be as high as 85° C. which is an upper limit for the materials of the vessels. Driving reduces the temperature in storage vessels as the gas expands and pressure decreases. If the weather is cold and hydrogen flow from storage high (for example, under full engine load), the remaining hydrogen cools significantly. Depending on the design of the storage system and environmental influences, the gas flow temperature may reach −80° C. when, for example, the ambient temperature is −25° C. and after thirty minutes of full power fuel cell operation.

This substantial range in pressures and temperatures makes it difficult to control hydrogen gas flow. Moreover, pressurized hydrogen may react with some metal container materials and is capable of leaking through small openings. It has been difficult to design flow control pressure regulators that are effective and efficient in managing the flow rate of hydrogen from a storage vessel to the anode chambers of a fuel cell stack when the regulators may be subjected to such temperature and pressure cycling.

### SUMMARY OF THE INVENTION

A pressure regulator is adapted and provided for control of hydrogen gas flow from high pressure storage to a lower pressure hydrogen-using device.

In an illustrative embodiment of the invention, the regulator has a body for accommodating a piston module (comprising a piston head and stem) and one or more combinations of a flexible corrugated tubular bellows with static seals fixing the tubular ends of the bellows in the regulator body as are described. One or more bellows of hydrogen impermeable material (e.g., thin sheets of stainless steel or polyethylene) are used to separate pressure chambers within the regulator. Other types of metallic or plastic, flexible and expansible vessels can be used to provide the function of a bellows. Preferably, the regulator body is round.

The regulator body has a central longitudinal axis for hydrogen flow from one end of the flow axis to the other. The regulator body is adapted to accommodate reciprocal movement of the piston head and attached stem along the axis. One end of the pressure regulator body has an end surface with an opening and inlet passage for receiving higher pressure hydrogen gas. The inlet passage may terminate with a sealing surface within the body for engagement with the unattached end of the piston stem. The opposite end of the regulator body (with respect to the central flow axis) is open for assembly of the piston module and bellows and sealing elements in the body. When the regulator has been assembled, the regulator body is closed with a bonnet, lid, or other suitable closure member. The piston head lies adjacent the closure member. The closure member has an opening for the flow of lower pressure hydrogen from the regulator to another regulator or hydrogen-consuming device.

The unattached end of the piston stem has an opening (such as a diametrical bore) and a central duct or bore for flow of hydrogen up the piston stem and through a central opening in the piston head toward the hydrogen gas outlet in the closure. The regulator body is shaped to form an internal chamber of higher pressure hydrogen around the piston stem to force hydrogen gas into the flow duct in the stem. The regulator body, piston head, and closure member also form an internal chamber of lower pressure hydrogen gas at the gas flow outlet from the regulator.

In many embodiments of the invention, the regulator body will also be shaped to accommodate a coil spring (or other expanding device) to exert a predetermined force on the stem side of the piston head. The portion of the regulator body containing the spring is typically vented to the atmosphere so that this chamber of the body does not see hydrogen flow and is maintained at atmospheric pressure. But high pressure hydrogen acts on the piston stem and enters the axial flow passage through the stem and piston head. And lower pressure hydrogen acts on the piston head against the spring force. It is the response of the piston to spring force acting on one side of the piston head and hydrogen gas pressure acting on the other side of the piston head that prompts movement of the piston head and stem toward and away form the sealing seat of the hydrogen gas inlet. The regulator structure so far described accounts for the regulating function of the device. But means must be provided for preventing leakage of hydrogen within and from the regulator and for permitting low friction movement of the piston along the axis of the regulator.

In accordance with some embodiments of the invention, a first tubular bellows of corrugated shape is used to confine higher pressure hydrogen gas around the piston stem and the opening into the stem passage. The first bellows may also prevent hydrogen from entering the spring-containing chamber of the regulator which is at nominal atmospheric pressure. One tubular end of the first bellows is attached to the regulator body using a static seal or its equivalent. The other end of the bellows is attached to the piston (head or stem or both) using a second static seal device or the equivalent. The parallel ridges and valleys of the flexible corrugated bellows tube permit it to readily lengthen and shorten in accommodation of axial movement of the piston module in response to hydrogen pressure differentials on opposite faces of the piston head.

The bellows and seals may be formed of materials that are impervious to hydrogen gas and operable in the temperature and pressure environment of the regulator. For example, the corrugated tubular bellows may be formed of a stainless steel tube or a polyethylene (preferably ultrahigh molecular weight polyethylene) tube. Sometimes the bellows may comprise a metal layer and a polymer layer. The seals are typically in the shape of rings bonding the tubular ends of the bellows to adjacent body or piston surfaces. Such seals may be made of a suitable resilient polymeric material and may contain internal metal springs that energize or bias the bellows end against contacting surfaces to prevent leakage of hydrogen. In some embodiments a seal is formed by a seam weld between a bellows end and an adjacent regulator element.

In other embodiments of the invention, a second combination of a tubular corrugated bellows and static end seals is used to confine hydrogen gas in the low pressure chamber between the piston head and gas outlet. One end of this second bellows is sealed to the perimeter of the piston head and the other end of the second bellows is sealed to the regulator body or closure member or both. The second bellows and seals may be formed of materials selected from the groups of materials that are found useful for the first bellows and its seals.

In some embodiments of the invention, supporting rings on the outer or inner circumference of the high pressure chamber bellows may provide support for it. And in some embodiments of the invention the inside surface or outside surface (or both surfaces) of the bellows may be coated with a dry lubricant like boron nitride or diamond-like carbon for lubrication.

Other objects and advantages of the invention will be apparent from detailed descriptions of preferred embodiments. In these descriptions, reference will be made to drawing figures which are briefly described in the following section of this specification.

### BRIEF DESCRIPTION OF THE DRAWINGS

FIG. 1 is a cross-sectional view of a high-pressure regulator having a bellows in each of the high pressure and low pressure chambers in combination with separate spring-biased static ring seals.

FIG. 2 is a cross-sectional view of a high-pressure regulator having a bellows in each of the high pressure and low pressure chambers in combination with separate conventional static ring seals.

FIG. 3 is a cross-sectional view of a high-pressure regulator having a bellows in each of the high pressure and low pressure chambers in combination with static seals formed as an integral part of each bellows.

FIG. 4 is a cross-sectional view of a high-pressure regulator having a bellows in each of the high pressure and low pressure chambers in combination with spring-biased static seals that are formed as integral parts of the bellows.

FIG. 5 is a cross-sectional view of a high-pressure regulator having bellows in each of the high pressure and low pressure chambers with spring-energized static seals that are part of the bellows. The low-pressure chamber bellows is welded to the piston.

FIG. 6 is a cross-sectional view of a high-pressure regulator having bellows in each of the high pressure and low pressure chambers with the bellows in the high pressure chamber also acting as the piston spring.

### DESCRIPTION OF PREFERRED EMBODIMENTS

In accordance with an embodiment of the invention, a pressure regulator described herein provides a regulator body that contains an interior piston assembly to control fluid flow through the regulator, especially hydrogen gas flow. The outlet pressure of the pressure regulator may remain substantially unaffected by variations in the relatively high inlet pressure by relying upon direct outlet pressure feedback to control the fluid pressure. A high pressure chamber is formed on one side of a piston head and a low pressure chamber on the other side. A combination of bellows and seals are used to define the chambers, thus minimizing leakage of hydrogen and facilitating low friction movement of a piston module. The pressure regulator uses a compressive force balance across the piston assembly to maintain the regulator outlet pressure at a predetermined pressure or set point. Examples of some preferred high-pressure regulators are described in the following specification.

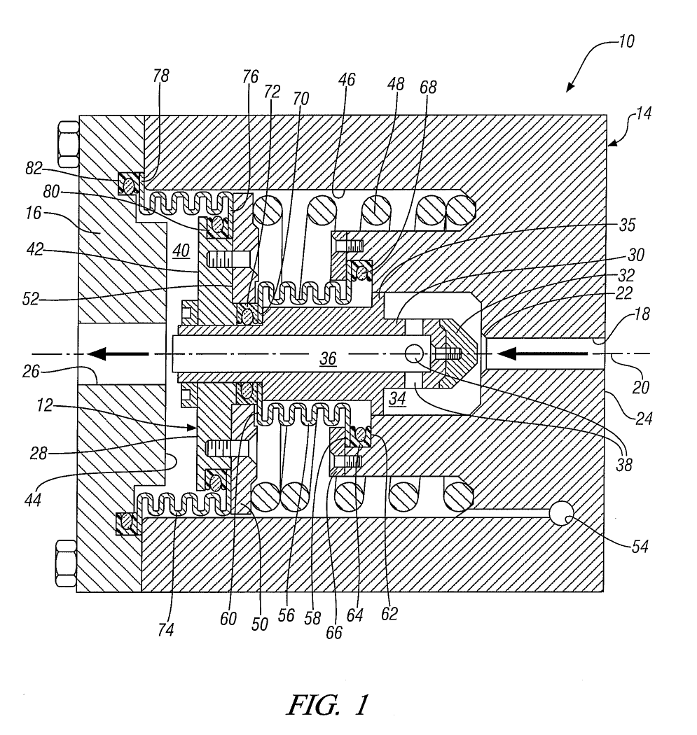

Referring now to FIG. 1, a cross-sectional view of a first embodiment of a pressure regulator 10 for a high-pressure gas dispensing system for a hydrogen fuel cell is shown. In general, and in this embodiment, high-pressure regulator 10 comprises a piston assembly or module 12 disposed within a substantially single or unitary round cylindrical body 14. A round, generally flat, closure disk 16 (lid or bonnet) is bolted to body 14. The round pressure regulator body 14 has a central round inlet passage 18 which extends along central axis 20 of regulator body 14. Inlet passage 18 terminates in a valve seat 22. The inlet face 24 or inlet passage 18 (or both) of regulator body 14 is adapted by means, not illustrated, to receive a tube or other conduit of high pressure hydrogen gas in a leak-free connection.

Round closure member 16 has a central outlet passage 26 (on regulator body axis 20) for the flow of relatively low pressure hydrogen gas to anode surfaces of a fuel cell. Outlet passage 26 is also adapted by means, not shown, for a gas-tight connection with a hydrogen flow conduit.

Piston assembly 12 comprises a relatively flat round piston head 28 centered on regulator body axis 20. Piston head 28 is attached to one end of a round hollow piston stem 30 (or shaft) which is also centered on regulator body axis 20. Attached (bolted in this example) to the upstream end (with respect to hydrogen flow) of piston stem 30 is a seal 32 of truncated cone shape adapted to engage inlet valve seat 22. Piston stem 30 fits into a round cylindrical chamber 34 of regulator body 14. A circumferential flange 35 on piston stem 30 loosely centers the piston stem from the adjacent cylinder body wall. Chamber 34 receives relatively high pressure hydrogen gas through pressure regulator inlet 18 and valve seat 22. As illustrated in FIG. 1, the piston module 12, including piston stem 30 is shown in an open position for receiving high pressure hydrogen gas in pressure regulator 10.

Piston stem 30 has a longitudinal axial bore-passage 36 with two right-angle diametrical bores 38 for admission of high pressure hydrogen gas from regulator body chamber 34. Hydrogen gas flows through passage 36 into a relatively low pressure chamber 40 between the outer (downstream) surface 42 of piston head 28 and the inner surface 44 of closure member 16. Low pressure hydrogen gas exits low pressure chamber 40 through pressure regulator outlet passage 26.

Pressure regulator body 14 has a radially outer chamber 46 shaped to receive a suitable spring 48 or other device for applying a force against reaction plate 50 bolted to the inside surface 52 of piston head 28. The force of spring 48 tends to move the piston stem 30 away from valve seat 22 to admit high pressure hydrogen into the regulator 10. Chamber 46 is shaped to receive, enclose, and seat one end of spring 48. Chamber 46 is vented through vent passage 54 to the atmosphere. Thus, chamber 46 is maintained at substantially atmospheric pressure during operation of pressure regulator 10.

Spring 48 acts with a predetermined force on inside surface 52 of piston head 28 while hydrogen pressure in low pressure chamber 40 acts on the outside surface 42 of piston head 28. Piston module 12 moves in reaction to any imbalances in these respective forces in operation of pressure regulator 10. In accordance with embodiments of this invention, the low friction movement of piston module 12 and retention of flowing hydrogen in the pressure regulator 10 are managed by the use of suitable seals and one or more chamber defining bellows.

A first bellows 56 separates high hydrogen pressure chamber 34 from ambient pressure chamber 46. Bellows 56 is shaped like a corrugated round tube with radially extending flat ends 58, 60. Bellows 56 may be suitably formed of a sheet material of, for example, stainless steel or ultrahigh molecular weight polyethylene that is impervious to hydrogen at the operating temperatures and pressures of the pressure regulator 10 and retains flexibility for its function that will be described further.

Bellows end 58 extends radially outwardly from a radial groove of bellows 56 and is rigidly fixed to a corresponding internal shoulder 62 on regulator body 14 against an intervening C-shaped ring seal body 64. Bellows annular end 58 is clamped against a side of a radially inwardly facing, C-shaped ring seal body 64 with a bolted clamp ring 66. Ring seal body 64 comprises an internal spring 68 that prevents leakage of hydrogen through the attachment of bellows end 58 to shoulder 62 of regulator body 14.

Bellows end 60 is clamped between shoulder 70 of round piston stem 30 and piston head 28 with intervening C-shaped ring seal 72. In this embodiment, C-shaped ring seal 72 has a smaller diameter than seal 64 but seal 72 is spring energized using a seal construction like that of seal 64. The C-shaped body portions of seals 64 and 72 may be formed of a suitably flexible synthetic polymer material that is generally impervious to hydrogen. The internal spring members of these seals may be suitably formed of metal coils or bent sheet metal strips that are shaped in a known manner to bias the polymeric seal bodies against the bellows and adjacent regulator surfaces to be sealed.

Thus, the parallel alternating ridges and grooves of corrugated bellows 56 permit bellows 56 to freely lengthen and shorten as piston module 12 reacts to hydrogen pressures in chambers 34 and 40 and to spring 48. But seals 64 and 72 do not move; they function as static seals. Dynamic seal designs are not required in the pressure regulator of this invention because of the use of bellows.

A second bellows 74 separates high pressure chamber 40 from ambient pressure chamber 46. In this embodiment, bellows 74 is of larger diameter than bellows 56 but is of similar shape and function. Bellows 74 is shaped like a corrugated round tube with flat radially-extending ends 76, 78. Radially inwardly extending bellows end 76 is fixed between reaction plate 50 and piston head 28 by spring energized, static, C-shaped ring seal 80. Bellows end 78 is clamped between pressure regulator body 14 and closure member 16 using spring energized, static, C-shaped ring seal 82. Seals 80 and 82 may be formed polymeric bodies and energizing springs like the constructions of seals 64 and 72.

Low pressure chamber bellows 74 (like high pressure chamber bellows 56) may be made of stainless steel or UHMW-PE sheet material or other suitably flexible and hydrogen impervious material. And again, the parallel alternating ridges and grooves of corrugated bellows 74 (like the corrugations of bellows 56) readily permits bellows 74 to lengthen and shorten as piston module 12 reacts to hydrogen pressures in chambers 34 and 40 and to spring 48.

The above described combinations of bellows with static seals for defining and sealing the high pressure chamber and the low pressure chamber of pressure regulator 10 confines hydrogen within the regulator and allows for free and responsive movement of the piston module. Direct sealing contact is not required between the piston head or stem and surrounding surfaces of the regulator body. The respective bellows move with the piston and confine the flowing hydrogen gas. Static seals may be employed that do not have to slide against a contacting surface as they function to retain the flow of hydrogen within regulator 10.

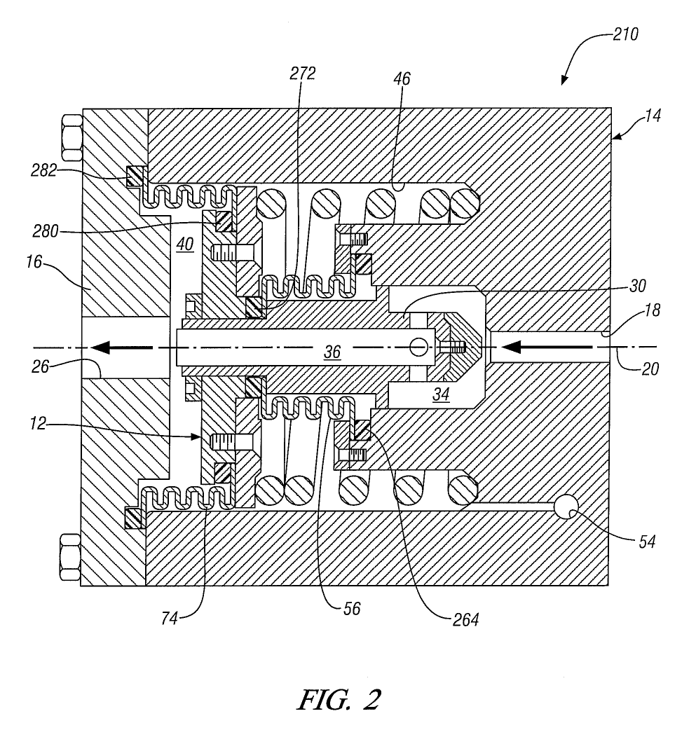

Other embodiments for fixing and sealing bellows members to pressure regulator components will be described with reference to drawing FIGS. 2-6. For simplicity of illustration the shape of the piston module and enclosing body members are not significantly changed and parts or components that are not changed are identified with the same numerals as are employed in description of pressure regulator body 10 of FIG. 1. However, different ways of sealing or fixing the ends of the respective bellows will be described. Where a feature of a bellows, a seal or other regulator component has been changed it is identified with a three digit number including, as the first digit, the number of the figure and, as the following two digits, the numbers generally associated with the part. For example, seals 264 and 272 described in FIG. 2 serve a similar function, but are somewhat changed in shape or function from seals 64 and 72 described with reference to FIG. 1.

In FIG. 2, high pressure chamber bellows 56 and low pressure chamber bellows 74 are of the same structure and materials as described in the embodiment of FIG. 1. The only difference in the FIG. 2 embodiment is that pressure regulator 210 comprises static seals 264 and 272 used with high pressure chamber bellows 56 are not spring energized. Solid ring seals 264 and 272 may, for example, be made of aluminum or polytetrafluoroethylene. Likewise, solid ring seals 280 and 282 used with low pressure chamber bellows 74 are not spring energized. Solid ring seals may also be made of aluminum or polytetrafluoroethylene.

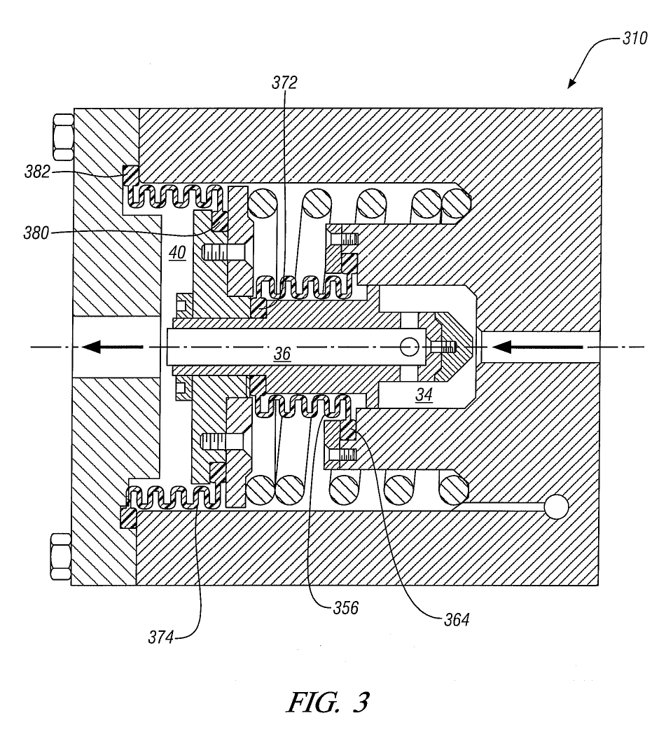

In the embodiment of the pressure regulator 310 construction of FIG. 3, high pressure chamber corrugated tubular bellows 356 and associated static ring seals 364 and 372 are formed as an integral bellows/seal structure. The bellows/seal seal structure may be molded of a suitable polymer such as ultrahigh molecular weight polyethylene. Ring seal bodies 364, 372 are molded to the annular ends of bellows 356. Likewise, low pressure chamber corrugated tubular bellows 374 is formed with integral ring seal bodies 380, 382 formed at the ends of bellows 374.

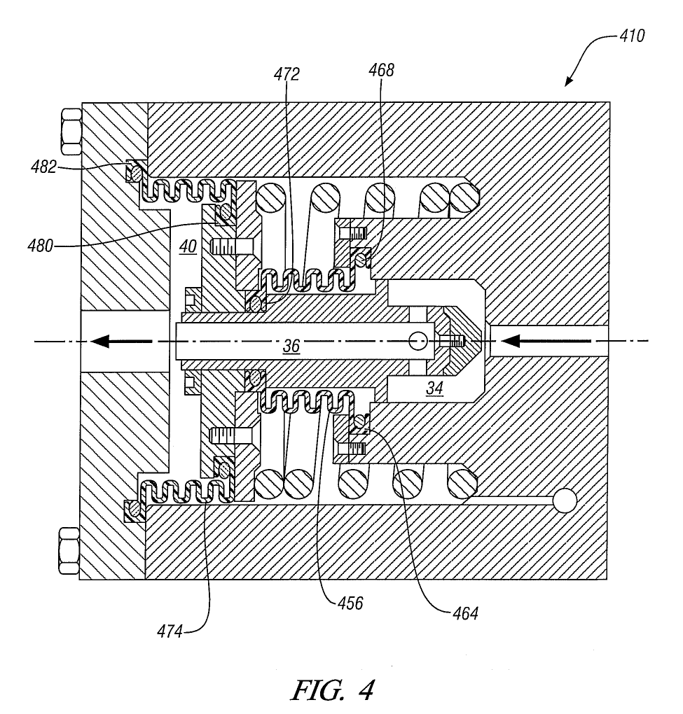

In the embodiment of the pressure regulator 410 construction of FIG. 4, high pressure chamber corrugated tubular bellows 456 is molded, or otherwise formed with integral ring seal bodies 464 and 472 at the annular ends of the bellows. Again, the bellows 456 and ring seal bodies 464 and 472 may be molded of polyethylene or other suitable material. In this embodiment, however, each of ring seal bodies contains a spring (as illustrated as spring 468 in seal body 464). Spring body 472 contains a like molded-in or implanted metal spring, such as those described in connection with the FIG. 1 illustration of this invention. Similarly, low pressure chamber bellows 474 has integral ring seal bodies 480 and 482 at the ends of the bellows 474. And ring seal bodies 480, 482 contain internal springs for urging seal bodies against adjacent surfaces of the pressure regulator 10.

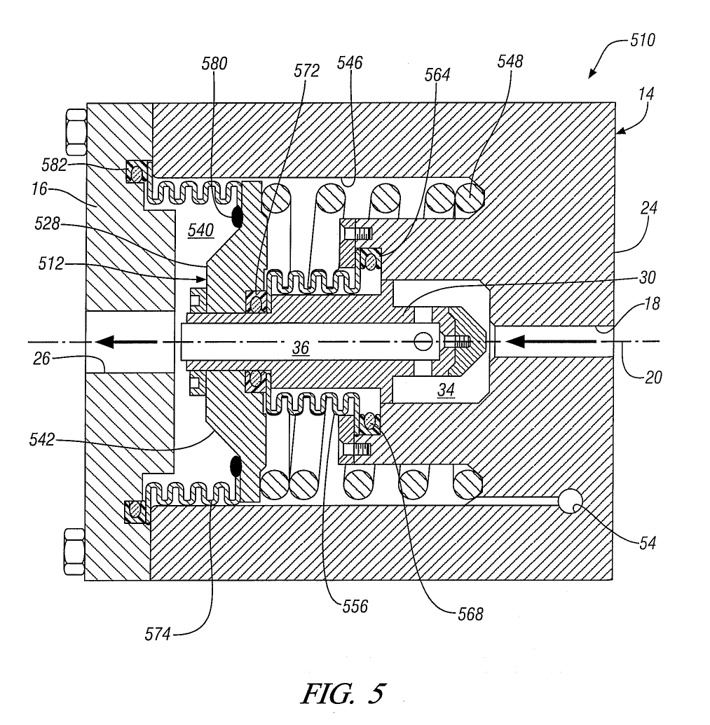

In the embodiment of FIG. 5, piston module 512 of pressure regulator 510 does not include a reaction plate (like plate 50 in FIG. 1) bolted to the upstream side of piston head 528. Spring 548 bears directly against the upstream face of piston head 528.

One annular end of low pressure chamber bellows 574 is attached to the downstream face of piston head 528 with a linear (circular) seam weld 580. Seam weld 580 replaces a static seal, like spring-energized ring seal 80 in FIG. 1. The other annular end of low pressure chamber bellows 574 is clamped between pressure regulator body 14 and closure member 16 with spring-energized static ring seal 582.

In this example, high pressure chamber bellows 556 is secured to regulator body 14 with spring-energized static ring seal 568 and to the upstream side of piston head 528 with spring-energized static ring seal 572.

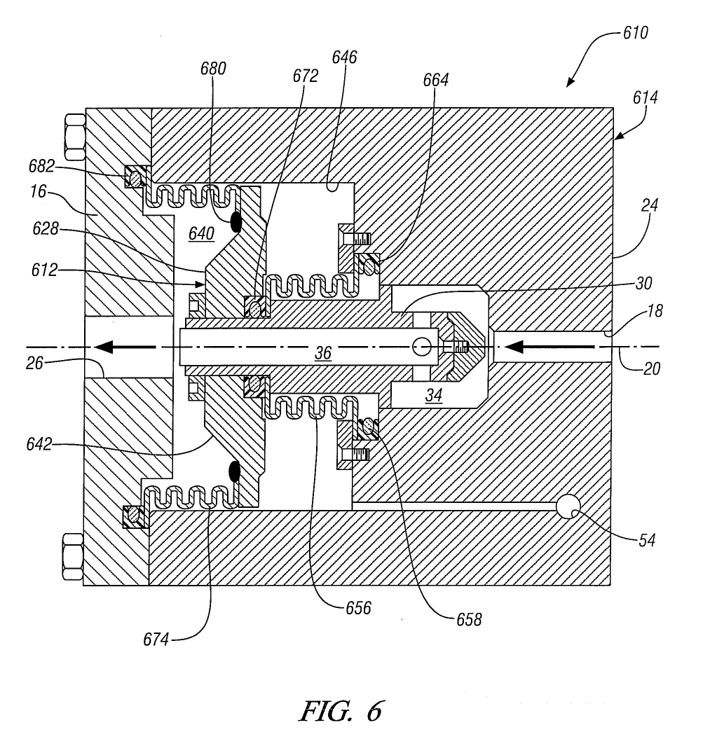

In the embodiment of FIG. 6 regulator body 614 of pressure regulator 610 has been modified to eliminate the use of a spring such as is illustrated at 48 in the FIG. 1 embodiment and in FIGS. 2-5. In this example, high pressure chamber bellows 656 is adapted to apply a spring force in the upstream side of piston head 628. For example, bellows 656 may be made with stainless steel such that the corrugated shape of the tubular bellows applies a suitable spring force for regulator function.

In this embodiment, low pressure chamber bellows 674 is fixed at one end by seam weld 680 to the down stream face of piston head 628 and at the other end it is clamped between pressure regulator body 614 and closure member 16 with spring-energized static ring seal 682.

The pressure regulators of this invention are adapted for pressure reduction and flow control of a gas like hydrogen which tends to react with some materials and leak through small openings. The pressure regulators use a selected combination of bellows and static seals to enhance the performance of a pressure regulator to be used in managing the flow of hydrogen gas from a high pressure storage site to a low pressure application such as in anode chambers of a fuel cell. In some embodiments it is preferred to use a bellows in defining both a high pressure chamber and a low pressure chamber of the regulator. In other embodiments it may be preferred to use a bellows for one pressure chamber and a different means, such as dynamic seals, for the other chamber. Various combinations of bellows and static sealing means have been illustrated in this specification. But obviously other combinations of bellows and static seals may be used within the scope of this invention.

1. A pressure regulator for controlling a flow of hydrogen gas from a source of hydrogen at a first hydrogen gas pressure to a hydrogen-using device at a lower hydrogen gas pressure, the pressure regulator comprising:
a piston comprising a piston head and a piston stem, the piston head and stem having a longitudinal axis, the piston stein having a distal end opposite the piston head and defining a flow passage for hydrogen that extends from a flow passage inlet at the distal end and along the longitudinal axis and through the piston head at a flow passage outlet;
a regulator body with a central longitudinal axis, the body having an inlet for hydrogen gas at the first pressure at one end of the central axis and an opening at the other end of the central axis, the inlet terminating in a sealing seat, the body being further shaped to accommodate the piston head and piston stein with the distal end of the stem being movable along the central axis into engagement with the sealing seat of the inlet and the piston head and its flow passage outlet being aligned within the opening of the regulator body at the central longitudinal axis;
a closure member attached to the end the regulator body having the opening, the closure member having an outlet for hydrogen gas at the lower hydrogen pressure, the outlet being centered on the central longitudinal axis of the regulator body and on the flow passage outlet in the piston head; and
an expansible vessel with one end attached with a first static seal to the regulator body and a second end attached with a second static seal to the piston stem so that inside of the vessel defines a first hydrogen gas flow chamber between the regulator body and the piston stem thereby directing hydrogen gas flow from the hydrogen gas inlet into the flow passage in the piston stem, the vessel accommodating axial movement of the piston along the central longitudinal axis.

2. A pressure regulator as recited in claim 1 in which the expansible vessel has a cylindrical tubular shape.

3. A pressure regulator as recited in claim 1 in which the expansible vessel is a tubular conjugated bellows.

4. A pressure regulator as recited in claim 1 in which the outside of the expansible vessel accommodates an atmospheric pressure chamber in the regulator.

5. A pressure regulator as recited in claim 1 in which the expansible vessel is formed of stainless steel sheet material or polyethylene sheet material.

6. A pressure regulator as recited in claim 1 in which at least one of the first and second static seals comprise a spring-biased ring.

7. A pressure regulator as recited in clam 1 in which a spring force is applied to the piston head to urge the piston stem away from the hydrogen inlet sealing seat.

8. A pressure regulator as recited in claim 1, the regulator further comprising:
a second hydrogen gas flow chamber between the piston head and the closure member, hydrogen gas flowing from the piston head into the second chamber to exert a gas pressure on the piston head and to flow from the second chamber through the outlet in the closure member.

9. A pressure regulator as recited in claim 8 in which a second expansible vessel with one end attached with a third static seal to the piston head and another end attached with a fourth static seal to the regulator body or closure member to define the second hydrogen gas flow chamber and to prevent leakage of hydrogen from the regulator apart from intended flow of hydrogen gas through the outlet in the closure member, the vessel accommodating axial movement of the piston along the longitudinal axis.

10. A pressure regulator as recited in claim 9 in which the second expansible vessel is a tubular corrugated bellows.

11. A pressure regulator as recited in claim 9 in which the expansible vessel is formed of stainless steel sheet material or polyethylene sheet material.

12. A pressure regulator as recited in claim 9 in which at least one of the first and second static seals comprise a spring-biased ring.

13. A pressure regulator for controlling the flow of hydrogen gas from a source of hydrogen at a first hydrogen gas pressure to a hydrogen-using device at a lower hydrogen gas pressure, the pressure regulator comprising:
a piston comprising a piston head and a piston stem, the piston stem having a distal end opposite the piston head and defining a flow passage for hydrogen that extends from a flow passage inlet at the distal end to a flow passage outlet at the piston head;
a regulator body having at one end an inlet for hydrogen gas at the first pressure and at the other end an opening, the inlet terminating in a sealing seat, the regulator body being further shaped to accommodate the piston with the distal end of the stem being movable into engagement with the sealing seat of the inlet;
a closure member attached to the end of regulator body having the opening, the closure member having an outlet for hydrogen gas at the lower hydrogen pressure, the outlet being aligned with the flow passage outlet in the piston stem;
a first tubular corrugated bellows with one end attached with a first static seal to the regulator body and a second end attached with a second static seal to the piston stem, the inside of the bellows sealing a first hydrogen gas flow chamber between the regulator body and the piston stem thereby directing hydrogen gas flow from the hydrogen gas inlet into the flow passage in the piston stem, the outside of the tubular bellows accommodating an atmospheric pressure chamber that is vented to the atmosphere, the first tubular bellows further accommodating axial movement of the piston;
a second tubular corrugated bellows with one end attached with a third static seal to the piston head and another end attached with a fourth static seal to the regulator body or the closure member to contain a second hydrogen gas flow chamber between the piston head and the closure member that receives hydrogen flow from the flow passage outlet at the piston stem, the hydrogen flow flowing from the second hydrogen gas chamber through the outlet in the closure member and exerting a gas pressure on the piston head, the second tubular bellows further accommodating axial movement of the piston head; and
a spring located within the atmospheric pressure chamber of the regulator body and applying a spring force to the piston head to urge the piston stem away from the hydrogen inlet sealing seat.

14. A pressure regulator as recited in claim 13 in which at least one of the first and second tubular corrugated bellows is formed of a material comprising at least one of stainless steel sheet material and polyethylene sheet material

15. A pressure regulator as recited in any of claim 13 in which at least one of the first, second, third, and fourth static seals comprise a spring-biased ring seal.
